(19) United States
(12) Patent Application Publication
(10) Pub. No.: US 2012/0270558 A1
(43) Pub. Date: Oct. 25, 2012

(54) System and Method for Providing Geographically-Relevant Informantin to Mobile Users

(75) Inventors: Alexander Busch, Muenchen (DE); Andreas Winckler, Mountain View, CA (US)

(73) Assignee: Bayerische Motoren Werke Aktiengesellschaft, Muenchen (DE)

(21) Appl. No.: 13/092,715

(22) Filed: Apr. 22, 2011

(51) Int. Cl. H04W 24/00

(52) U.S. Cl. 455/456.1

(57) ABSTRACT

Geographically-relevant information is provided to mobile users by having an information source provide location-referenced information to one or more backend server systems. In response, the backend server system determines a region for which the received location-referenced information is relevant, and then identifies one or more specific cellular base stations that provide wireless broadcast service over an actual broadcast region which covers at least a majority of the determined region. A condition message may then be provided to each of the identified cellular base stations, which are correspondingly instructed to wirelessly broadcast the message over the actual broadcast region.

### FIELD OF THE INVENTION

The present invention relates generally to providing geographically-relevant information to mobile users, and more particularly to providing a broadcast of information over a cellular network that is geographically-limited so as to be receivable only by those mobile users to which the broadcasted information would be relevant.

### BACKGROUND OF THE INVENTION

Wireless communications between vehicles, as well as and between vehicles and traffic infrastructures, have been studied for many years from the perspective of improving safety and improving more efficient traffic management in the future. For this purpose, particularly radio technologies on a Wireless Local Area Network (WLAN) basis have been proposed in the form of Dedicated Short Range Communications (DSRC). However, DSRC requires equipping vehicles and traffic infrastructures with corresponding radio hardware. This results in considerable increased costs to the operator of the infrastructure and for the production of the vehicles. At the same time, no other communication system that is both robust and efficient enough to handle such large amount of data has been proposed.

Therefore, there is a need for providing geographically-relevant information to mobile users without the additional hardware expenditures required by a DSRC system, but which is also able to accommodate large amounts of data in a cost-effective manner.

### SUMMARY OF THE INVENTION

Disclosed and claimed herein are systems and methods for providing geographically-relevant information to mobile users. In one embodiment, a method includes receiving, by one or more backend servers over a network connection, location-referenced information from an information source, wherein the location-referenced information comprises an indication of a geographic location of the information source. The method further includes having the one or more backend servers determine a region for which the received location-referenced information is relevant, and then identify one or more cellular base stations that provide wireless broadcast service over an actual broadcast region which covers at least a majority of the determined region. The one or more backend servers are further to provide a condition message to each of the identified cellular base stations, wherein the condition message is based on the location-referenced information, and further to instruct the identified base stations to wirelessly broadcast the condition message over the actual broadcast region, wherein the condition message is configured to be receivable by cellular-enabled mobile terminals within the actual broadcast region.

Other aspects, features, and techniques of the invention will be apparent to one skilled in the relevant art in view of the following description of the exemplary embodiments of the invention.

### BRIEF DESCRIPTION OF THE DRAWINGS

The features, objects, and advantages of the present invention will become more apparent from the detailed description set forth below when taken in conjunction with the drawings in which like reference characters identify correspondingly throughout and wherein:

FIG. 1 is a block diagram illustrating an exemplary communication system in which one or more aspects of the invention may be implemented;

FIGS. 2A-2B illustrate a system configured to implement one or more aspects of the invention by providing traffic light information to only those that are likely to consider the information relevant, in accordance with the principles of the invention;

FIGS. 3A-3C illustrate a system configured to implement one or more aspects of the invention by providing hazardous condition information to only those that are likely to consider the information relevant, in accordance with the principles of the invention; and

FIG. 4 depicts a process for filtering broadcast condition messages based on a mobile operator's planned or estimated route, as implemented in accordance with the principles of the invention.

### DETAILED DESCRIPTION OF THE EXEMPLARY EMBODIMENTS

One aspect of the invention is to utilize existing cellular networks to provide various vehicle-to-vehicle communications and/or infrastructure-to-vehicle communications. However, since the use of cellular networks generates continuous costs depending on the data volume, a system and method which provides a high efficient utilization of available bandwidth is desirable. However, since current cellular communication is essentially on a one-to-one system between a vehicle and a backend server, for example, the resulting data volume and server load tends to increase linearly with the number of vehicles. Therefore, it is still another aspect of the invention is to provide a solution where the resulting data volume and server load do not increase linearly with the number of vehicles.

In certain embodiments, the invention may be implemented by a system and method in which distribution of information is limited to certain cellular base stations, so as to provide a geographical filtering of transmitted data that is limited to a broadcast region corresponding to the base station(s) location. Correspondingly, the actual transmitted data quantity may be thereby minimized.

Additionally, since all mobile users (e.g., vehicles, mobile terminals) within the above-reference broadcast region will equally receive the transmitted data, the volume of transmitted data will not increase as the number of wireless subscribers within the broadcast region increases.

The system and method disclosed herein is further advantageous in that the backend server is not required to carry out any subscriber-specific processing. The load of the server may therefore depend only on the number and the type of messages/data corresponding to the region of interest. In particular, the server load need not rise with the number of subscribers (e.g., vehicles) in the particular region of interest.

Additionally, the system and method disclosed herein may be scaled up well with respect to the transmission volume and server load, both neither depends on the number of receivers. In particular, using broadcast condition messages which correspond to a respective cellular standard (e.g., CDMA, GSM, UMTS, WiMax, LTE, etc.), any terminal suitable for this cellular standard will be capable of receiving and processing the broadcasted messages.

Finally, another aspect is to provide the aforementioned data transmissions in an encrypted format such that it may be properly received by only intended recipients, despite the free receptivity of the broadcast data.

As used herein, the terms “a” or “an” shall mean one or more than one. The term “plurality” shall mean two or more than two. The term “another” is defined as a second or more. The terms “including” and/or “having” are open ended (e.g., comprising). The term “or” as used herein is to be interpreted as inclusive or meaning any one or any combination. Therefore, “A, B or C” means “any of the following: A; B; C; A and B; A and C; B and C; A, B and C”. An exception to this definition will occur only when a combination of elements, functions, steps or acts are in some way inherently mutually exclusive.

Reference throughout this document to “one embodiment”, “certain embodiments”, “an embodiment” or similar term means that a particular feature, structure, or characteristic described in connection with the embodiment is included in at least one embodiment of the present invention. Thus, the appearances of such phrases or in various places throughout this specification are not necessarily all referring to the same embodiment. Furthermore, the particular features, structures, or characteristics may be combined in any suitable manner on one or more embodiments without limitation.

In accordance with the practices of persons skilled in the art of computer programming, the invention is described below with reference to operations that are performed by a computer system or a like electronic system. Such operations are sometimes referred to as being computer-executed. It will be appreciated that operations that are symbolically represented include the manipulation by a processor, such as a central processing unit, of electrical signals representing data bits and the maintenance of data bits at memory locations, such as in system memory, as well as other processing of signals. The memory locations where data bits are maintained are physical locations that have particular electrical, magnetic, optical, or organic properties corresponding to the data bits.

When implemented in software, the elements of the invention are essentially the code segments to perform the necessary tasks. The code segments can be stored in a processor readable medium or transmitted by a computer data signal. The “processor readable medium” may include any medium that can store information. Examples of the processor readable medium include an electronic circuit, a semiconductor memory device, a ROM, a flash memory or other non-volatile memory, a floppy diskette, a CD-ROM, an optical disk, a hard disk, etc.

The term “back-end server” means a functionally-related group of electrical components, such as a computer system in a networked environment which may include both hardware and software components, or alternatively only the software components that, when executed, carry out certain functions. The “backend server” may be further integrated with a database management system and one or more associated databases.

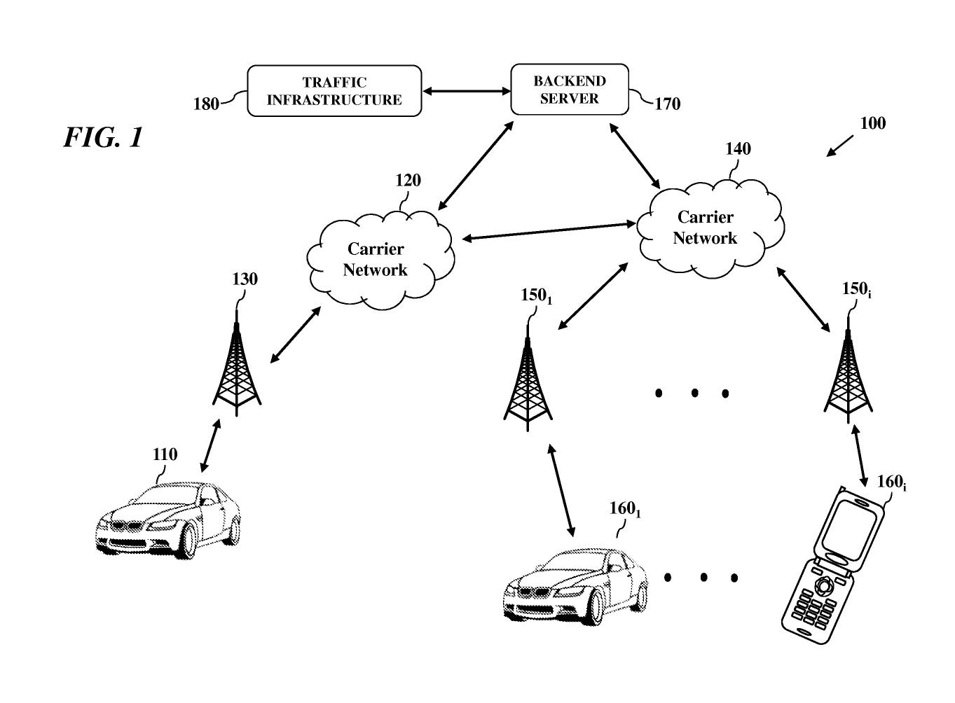

FIG. 1 illustrates a block diagram of a communication system 100 configured to implement one or more aspects of the invention. In one embodiment, the communication system 100 serves various mobile terminals, such as mobile terminal 110 which communicates with a carrier network 120 via a local base station 130. It should be appreciated that, while the mobile terminal 110 is depicted as being a cellular-capable vehicle in FIG. 1, the mobile terminal 110 may similarly be a cellular telephone, or any other cellular-capable electronic user device. It should be also appreciated that the mobile terminal 110 device may be capable of dispatch calling, interconnect calling, roaming, message mail and/or data communications.

Carrier network 120 may be configured to provide a myriad of network layer services, including but certainly not limited to location-based service, messaging service, conferencing service, presence service, etc. In addition, the mobile terminal 110 may be equipped to provide numerous features and may also include various applications, such as browser applications, chat clients, email clients, Java, personal information management applications, etc.

Continuing to refer to FIG. 1, the communication system 100 will preferably service additional mobile terminal 160₁-160ᵢ (“160”). In certain embodiments, mobile terminal 160 may be connected to a different carrier network 140 and serviced by separate base stations 150₁-150ᵢ (“150”). Moreover, as the mobile terminal 110 moves from having network coverage from carrier network 120 to a different carrier network (e.g., carrier network 140), the available network layer services may similarly change. In addition, it should be appreciated that carrier networks 120 and 140 may be GSM, CDMA, etc., and may be accessible using a variety of access technologies (e.g., IP Multimedia Subsystem (IMS)).

The communication system 100 further comprises a backend server 170 and traffic infrastructure 180. The backend server 170 may be integrated with either the carrier networks 120 and/or 140, or alternatively may have system-level access to the backbone(s) of one or more of the carrier networks 120 and/or 140 such that the backend server 170 is able to communicate directly with individual ones of the base stations 130 and 150.

It should also be appreciated that the backend server 170 may communicate with the traffic infrastructure 180 using any known communication means, including for example ground-bound lines, wirelessly, etc. Additionally, the backend server 170 may be implemented using a plurality of geographically dispersed servers, or may be implemented in a more centralized architecture. Finally, the traffic infrastructure 180 may comprise any form of known traffic-related infrastructure, including for example, traffic lights, traffic cameras, traffic congestion monitoring systems, traffic event reporting systems, and the like.

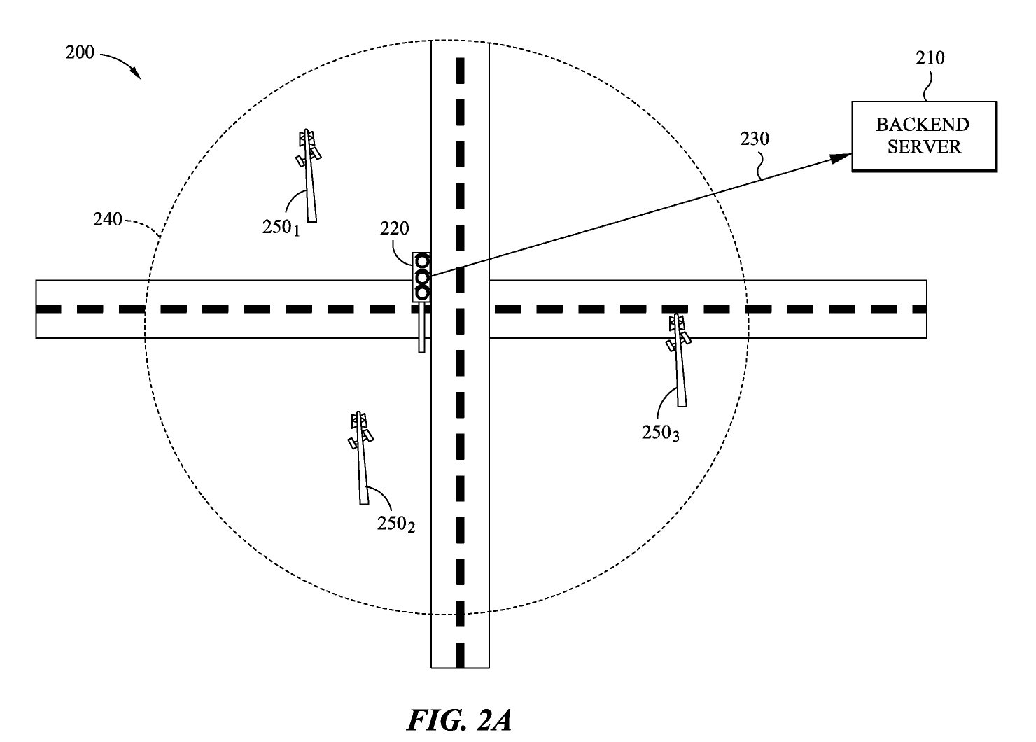

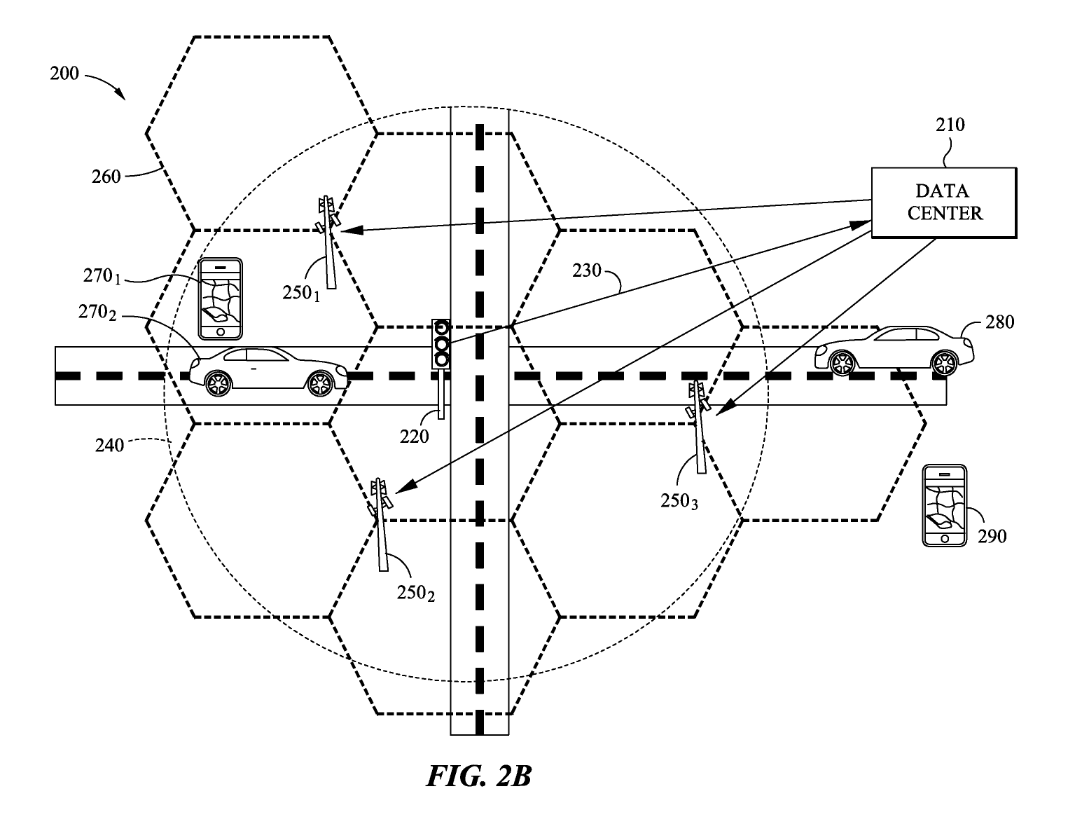

With reference now to FIG. 2A, depicted is one embodiment of a system 200 configured to implement one or more aspects of the invention. As shown, the system comprises a backend server 210 (e.g., backend server 170) configured to receive data from one or more location-specific information sources which, in the embodiment of FIG. 2A, comprises a traffic infrastructure (e.g., traffic infrastructure 180) in the form of a traffic light 220. While in the embodiment of the FIG. 2A the source is shown as being a traffic light 220, it should equally be appreciated that the source may be any infrastructure component or even another vehicle. Additionally, the information that is to be transmitted to the backend server 210 may comprise any information which may be of interest to other drivers, vehicles or mobile terminals that are within or otherwise approaching the same region to which the information relates.

The transmitted information 230 may preferably be location-referenced in the sense that the data includes or is otherwise associated with an indication that is representative of the particular geographic area to which the information relates. In the case of the traffic light of 220, this location-referenced information 230 transmitted to the backend server 210 may include an indication representative of the particular cross streets where the traffic light 220 is located, its GPS position, or any other indication that can be used to determine the particular geographic area for which the traffic light information would be relevant.

In the case of the traffic light 220, the location-referenced information 230 may include light signal and phase timing information. Additionally, the traffic light 220 (or any other type of source) may communicate with the backend server 210 by any known communications means, including ground-bound lines, wirelessly, etc. It may be preferably for the backend server 210 to be in spatial proximity to the location from which it is receiving data from the one or more location-specific sources (e.g., traffic light 220) in order to minimize data transmission times. However, a more centralized arrangement in which a fewer number of backend servers are used, including for example a single server, would similarly be consistent with the principles of the invention.

Continuing to refer to FIG. 2A, once the backend server 210 has receive the location-referenced information 230, the backend server 210 may then determine the region 240 for which the location-referenced information 230 may be relevant. This determination may be based on numerous factors including, for example, the type of information, the geographical circumstances in the surroundings of the location-referenced information 230, the particular layout of the streets/roads, the local speed limits, or other characteristics that are specific to the region surrounding the information source.

The operation of determining the region 240 may comprise determining one or more of the size and shape of the region 240. In the simple example of FIG. 2A, the shape of the region 240 may be determined to be approximately round since the information provided by the traffic light 220 would most likely be relevant to vehicles around the traffic light 220, irrespective of their approaching direction. Additionally, the size of the region 240 should be based, at least in part, on the speed limits surrounding the traffic light 220 since the speed at which vehicles approach the traffic light 220 will be directly proportional to how early the traffic light information will be regarded by the driver as being relevant.

Once the size and shape of the region 240 has been determined, the backend server 210 may then identify the particular base stations 250₁-250₃ that are capable of providing wireless broadcast coverage service to the determined region 240. It should be appreciated that the coverage provided by the identified base stations 250₁-250₃ need not perfectly equal the size and shape of the determined region 240 in order to be consistent with the principles of the invention. Rather, the identified base stations 250₁-250₃ may be selected by the backend server 210 such that the determined region 240 will have no coverage gaps, and possibly excess coverage in some directions (see e.g., FIG. 2B below). In contrast, the identified base stations 250₁-250₃ may be selected by the backend server 210 such that at least some minimum percentage (e.g., 90%) of the determined region 240 will be provided with broadcast coverage.

With reference now to FIG. 2B, the system 200 is depicted after location-referenced information 230 has been received by the backend server 210, after the relevant region 240 has been determined, and further after the particular base stations 250₁-250₃ that service the region have been identified. The actual broadcast region 260 corresponds to the actual area across which the identified base stations 250₁-250₃ provide wireless broadcast coverage. As shown in FIG. 2B, the actual broadcast region 260 may be different than the determined relevant region 240 due to the fixed locations of available base stations, their propagation patterns, characteristics of the terrain, etc.

In any event, once the determination is made as to the particular base stations 250₁-250₃ to which the location-referenced information 230 should be sent, the backend server 210 may then transmit one or more messages containing or corresponding to the previously-received location-referenced information 230 (as referred to herein as “condition messages”), along with an instruction to transmit the message(s) in a broadcast fashion. The backend server 210 may also indicate the duration of time over which the message(s) should be broadcast. The backend server 210 may further repeat the above-described process for as pieces of information that is received for a given region, including for information relevant to spatially overlapping broadcast regions.

The information contained in the broadcast condition messages may then be presented to the operator of the receiving device (e.g., mobile terminal, vehicle, etc.) in any known manner including, for example, visually on a display screen or audibly through a speaker. Since the numerous ways in which such information may be presented to a vehicle or mobile terminal operator are known in the art, such details will not be repeated herein.

In order to be able to determine the particular base stations 250₁-250₃ to select and to communicate directly with such identified base stations 250₁-250₃ in the manner disclosed herein, it may be beneficial or necessary for the backend server 210 to be integrated with the cellular network architecture that provides service to or otherwise implements wireless communications for a particular region. Alternatively, in a more centralized implementation, the backend server 210 may be integrated with or have system-level access to the backbones of a plurality of wireless communication networks. In any event, the particulars of how the backend server 210 may gain access to and communicate directly with base stations, as mentioned above with respect to the communication system 100 of FIG. 1.

Once the backend server 210 has instructed the identified base stations 250₁-250₃ to broadcast the condition message(s) corresponding to the received location-referenced information, any cellular-capable vehicles and mobile terminals will receive such cellular broadcasts upon entering the actual broadcast region 260. For example, in the embodiment of FIG. 2B, terminal 270₁ and vehicle 270₂ are located within the actual broadcast region 260 (i.e., within broadcast range of base station 250₁) and will correspondingly receive the broadcast condition message(s) having, in this example, the traffic light signal and phase timing information, which of course is based on the previously-provided location-referenced information 230.

Vehicle 280, which is just entering the actual broadcast region 260, will also begin to receive the traffic light signal and phase timing message(s) being broadcast by base station 250₃, since that would be the base station servicing the area into which vehicle 280 is moving. Conversely, however, since terminal 290 is just outside the actual broadcast region 260 it will not receive the traffic light signal and phase timing message(s), which of course is the intended result since terminal 290 is sufficiently far enough away from the traffic light 220 that its status information should likely not be regarded as relevant.

In this fashion, a system and method is provided in which distribution of information is limited to certain cellular base stations, so as to provide a geographical filtering of transmitted data that is limited to a broadcast region corresponding to the region in which the transmitted data is most likely to be relevant. Correspondingly, the actual transmitted data quantity is also thereby minimized.

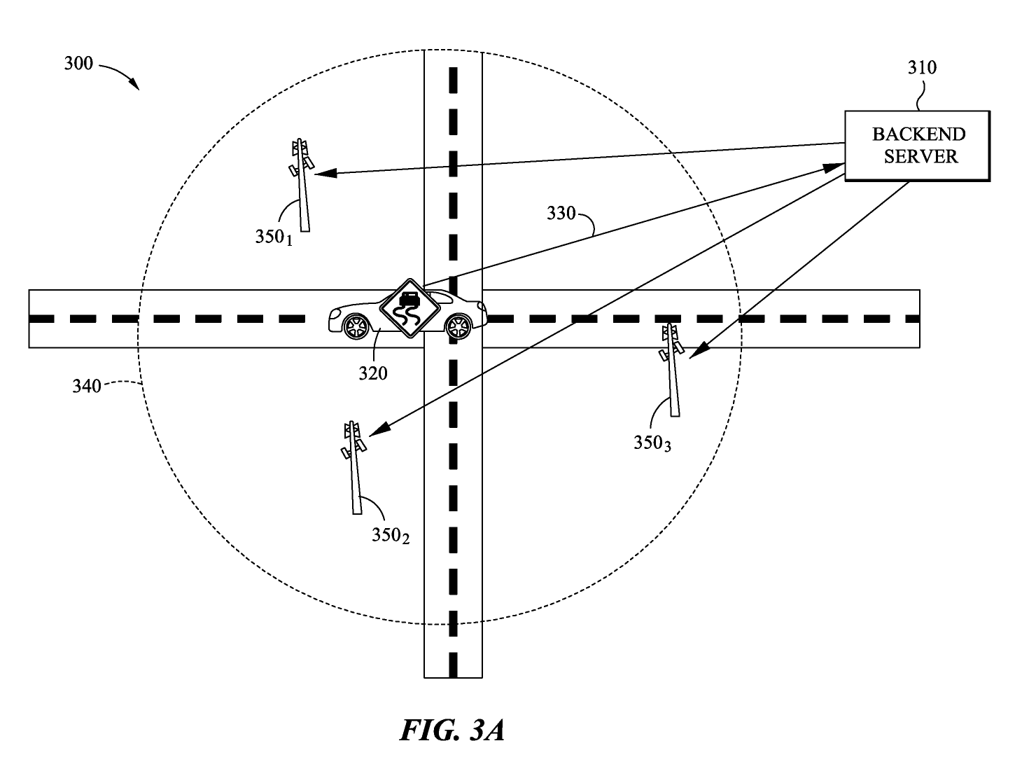

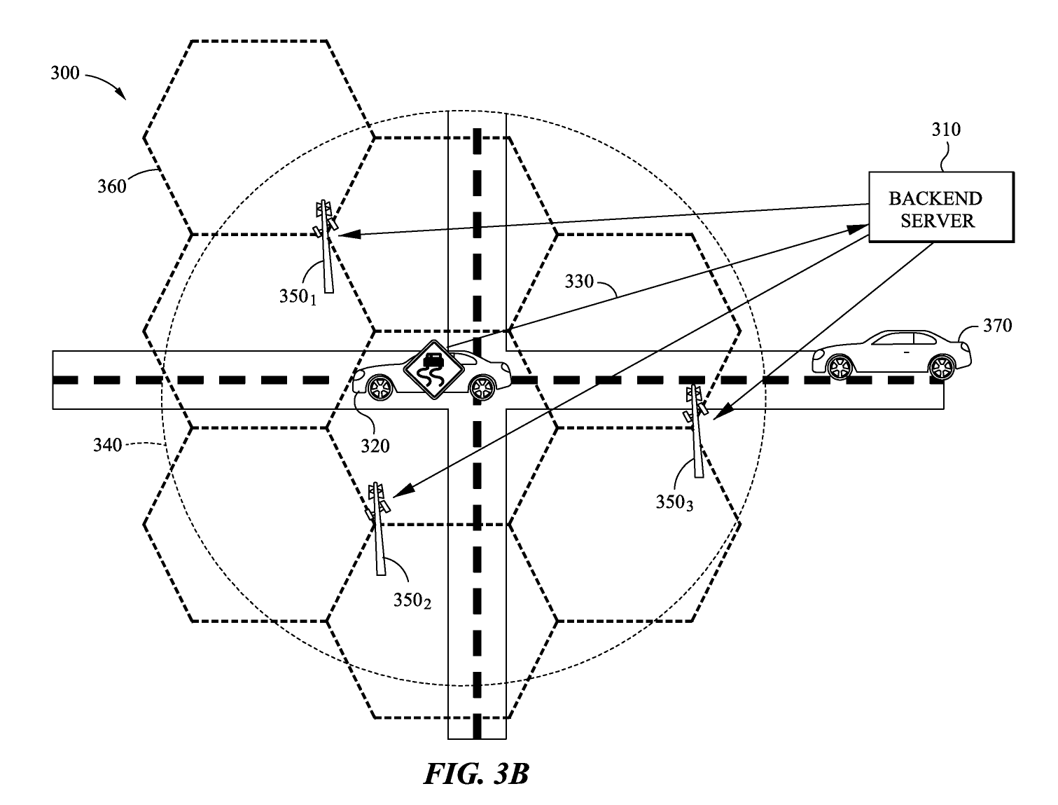

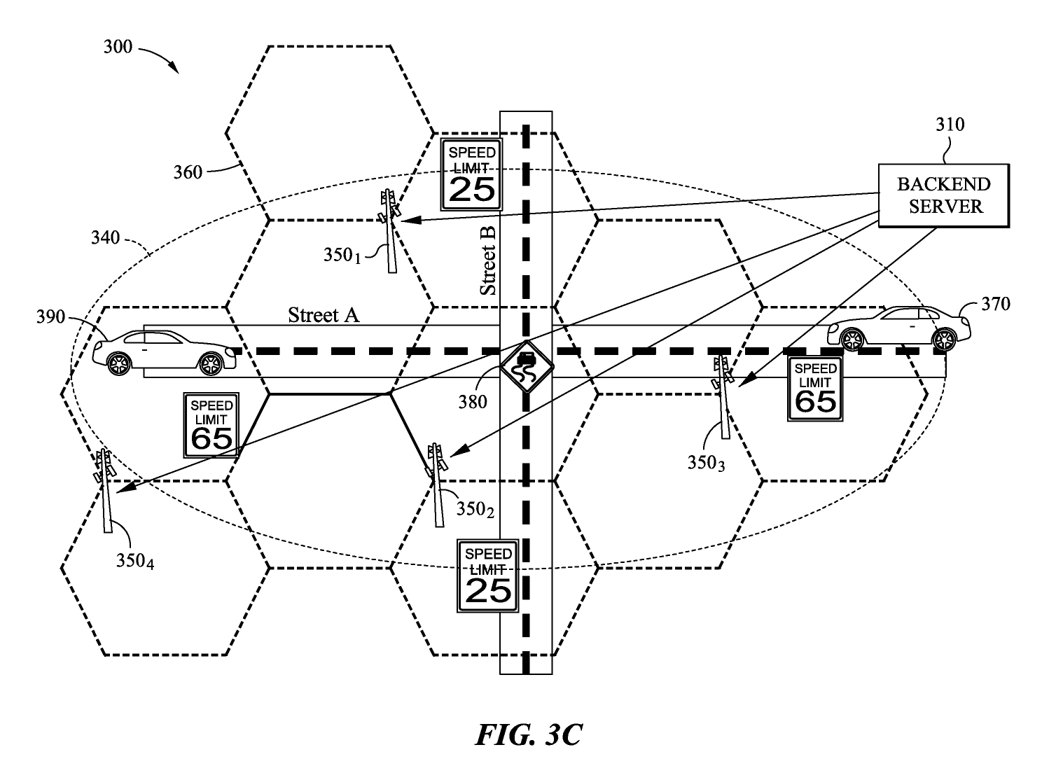

With reference to FIG. 3A, depicted is another example of a system 300 configured to implement one or more aspects of the invention. As with the system 200 of FIG. 2A-2B, the system 300 comprises a backend server 310 (e.g., backend server 170) configured to receive data from one or more location-specific sources which, in the embodiment of FIG. 3A, is another vehicle 320. Specifically, reporting vehicle 320 may provide information regarding a traffic hazard, such as an accident, in the form of the location-referenced information 330 transmitted to the backend server 310. In certain embodiments, the reporting vehicle 320 may be equipped with one or more sensors for detecting the occurrence of a traffic hazard at or near its location. By way of non-limiting example, the vehicle may detect that its airbag has deployed and signal to the backend server 310 that an accident has occurred, along with the corresponding location of the incident. Alternatively, one or more of the vehicle's onboard sensors may be used to detect potentially hazardous conditions, such as the existence of a slick driving surface detected by the vehicle's traction control sensors.

Regardless of the form of the hazard, the reporting vehicle 320 may transmit the pertinent location-referenced information 330 to the backend server 310 via a wireless communication channel. Upon the backend server 310 receiving the location-referenced information 330, a determination may then be made as to the particular size and shape of the region 340 for which the location-referenced information 330 may be relevant. And as previously described above, this determination may be based on numerous factors including, for example, the type of information, the geographical circumstances in the surroundings of the location-referenced information 330, the particular layout of the streets/roads, the local speed limits, or other characteristics that are specific to the region surrounding the information source.

In certain cases, the shape of the region 340 may be determined to be approximately round since the hazard would most likely equally affect vehicles approaching from any direction. Moreover, the size of the region 340 should be based, at least in part, on the speed limits surrounding the hazard since the speed at which vehicles approach will be directly proportional to how early the hazardous condition will be regarded by the driver as being relevant.

Once the size and shape of the region 340 has been determined, the backend server 310 may then identify the particular base stations 350₁-350₃ that are capable of providing wireless broadcast coverage service to the determined region 340. As described above in detail with reference to FIG. 2A, the broadcast coverage provided by the identified base stations 350₁-350₃ need not be perfectly coextensive with the determined region 340, but may similarly be somewhat over inclusive or even under inclusive, i.e., down to some minimum percentage (e.g., 90%) of the determined region 340.

With reference now to FIG. 3B, the system 300 is now shown after location-referenced information 330 has been received by the backend server 310, after the relevant region 340 has been determined, and further after the particular base stations 350₁-350₃ that service the region have been identified. The actual broadcast region 360 is that area across which the identified base stations 350₁-350₃ are actually capable of providing wireless broadcast coverage. As shown in FIG. 3B, the actual broadcast region 360 may be different than the determined relevant region 340 due to the fixed locations of available base stations, their propagation patterns, characteristics of the terrain, etc.

After identifying the particular base stations 350₁-350₃ to which the hazard information should be sent, the backend server 310 may then transmit one or more ‘condition’ messages containing details about the hazardous condition that was reported to have occurred in the area, along with an instruction to transmit such condition message(s) in a broadcast fashion. The backend server 310 may also indicate a duration of time over which the condition message(s) should be broadcast. Alternatively, the condition messages may be repeatedly sent until the backend server 310 is able to confirm that the hazard has been cleared, for example.

Once the identified base stations 350₁-350₃ begin to broadcast the condition message(s) corresponding to the reported hazardous condition, any cellular-capable vehicles and mobile terminals will be able receive such cellular broadcasts upon entering the actual broadcast region 360. For example, in the embodiment of FIG. 3B, vehicle 370 is just entering the actual broadcast region 360 (i.e., within broadcast range of base station 350₃) and will correspondingly receive the broadcast message(s) having, in this example, the hazardous condition information that was previously reported by vehicle 320, as described above. Additionally, it should be appreciated that the report hazard-related information may continue to be broadcast in the broadcast region 360, despite the fact that the original reporting vehicle 320 leaves the area.

Referring now to FIG. 3C, depicted is another aspect of the system 300 in which the size and shape of the region 340 is further based on, at least in part, the speed at which vehicles are expected to converge on a previously reported hazard 380. It should be appreciated that the reported hazard 380 may correspond to a hazardous condition (e.g., slick road, vehicle collision, road construction, heavy traffic, closed lane, etc.) that was reported by a traffic infrastructure (not shown), by a vehicle that is still in the affected area (not shown), or even by a vehicle that was in the affected are but which has now left the area.

In any event, FIG. 3C reflects the fact that the backend server 310 may be configured to adjust the shape and size of the region 340 based on the fact that the speed limit is much higher along “Street A” as compared to “Street B.” Thus, in this example, the backend server 310 has determined that the actual broadcast area 360 should be expanded to also include base station 350₄ so that approaching vehicle 390, which is expected to be traveling at approximately 65 along “Street A,” will receive the broadcast condition message relating to the reported hazardous condition 380 in an equally sufficient time as the slower vehicles approaching along “Street B.”

While the above description is based on the premise that the broadcast condition messages can be received by any terminal within the actual broadcast regions, it may should further be desirable to limit access to the broadcast information to only authorized terminals (e.g., subscribing terminals). Thus, it should be appreciated that at least some types of information in the aforementioned broadcast condition messages may be encrypted by the backend server so as to be available only to paying subscribers, while other information (e.g., safety-relevant warnings) may be made accessible in an unencrypted manner and otherwise free-of-charge.

Of course, it is likely that more than one type of condition message may be broadcast in a given area at the same time, e.g., road construction, traffic congestion, traffic light information, etc., and therefore the receiving terminals may preferably be configured to receive more than one cellular wireless broadcast at a time. However, presenting numerous such messages to the driver in a simultaneous or successive manner may be undesirable, particularly if not all of the condition messages would be entirely relevant to a particular driver. Therefore, another aspect of the invention is to provide the mobile operator with the ability to filter out condition messages, such as by type.

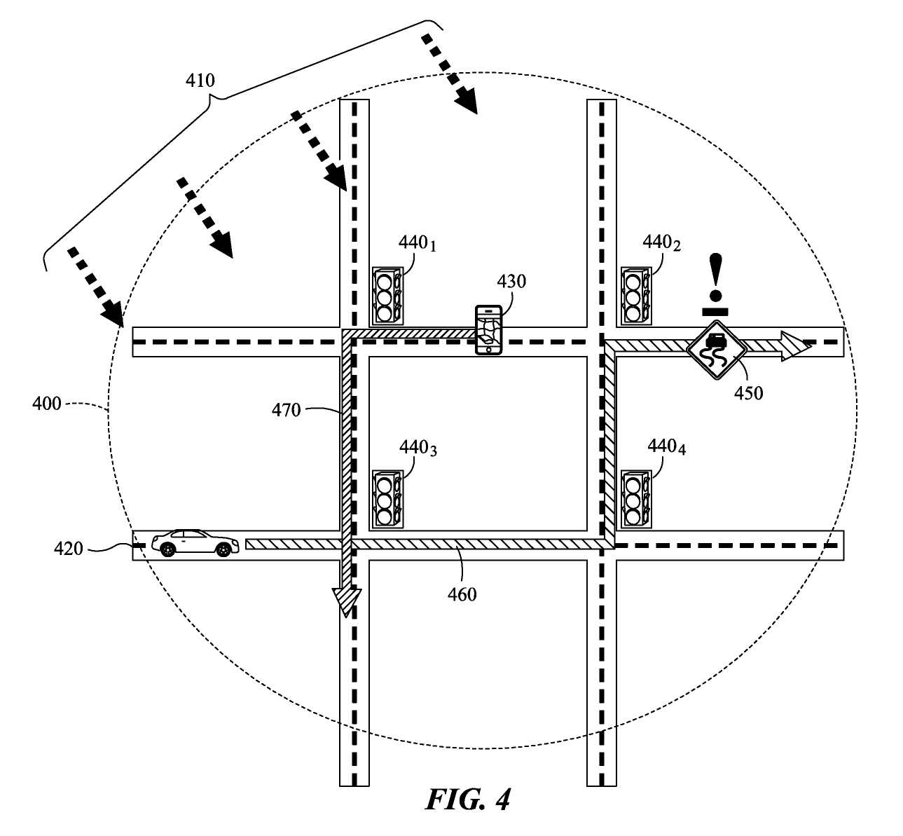

Another option for filtering out messages that are less likely to be relevant to a particular driver is to utilize information relating to the mobile operator's planned or estimated route. To that end, and with reference to FIG. 4, depicted is a particular broadcast region 400 across which a plurality of different broadcast condition messages 410 are being transmitted by one or more base stations (not shown), as described above, which correspond to various overlapping conditions/situations occurring within the region 400. The broadcast region 400 also includes four traffic lights 440₁-440₄ and a reported hazardous condition 450, which may have been reported by a previous passing vehicle that is no longer in the area, for example. In any event, the plurality of condition messages 410 may preferably include messages corresponding to the timing and phase information for each of the various four traffic lights 440₁-440₄, as well as for the reported hazardous condition 450.

Also depicted as being within the broadcast region 400 is a vehicle 420 and a mobile terminal 430. While it may be desirable for the vehicle 420 and mobile terminal 430 to receive and present each of the plurality of condition messages 410 to their respective operators, another aspect of the invention is to further filter such received broadcast condition messages 410 based on, for example, a planned or estimated route being traveled. In the example of FIG. 4, the route 460 being traveled by the vehicle 420 may be known by, for example, the vehicle's navigation system. Alternatively, the route 460 may be an estimated or predicted route based on historical information for the vehicle. In either case, the information from traffic light 440₁ is not likely to be relevant to the vehicle 420 since the vehicle's route 460 does not traverse that particular traffic light. Therefore, in certain embodiments, it may be desirable to filter out the particular message that corresponds to the traffic light 440₁ from the plurality of condition messages 410 that are otherwise presented to the driver of the vehicle 420. Similarly, since the information for traffic lights 440₁-440₄ and reported hazardous condition 450 are all relevant to the vehicles route 460, messages corresponding to those conditions would continue to be presented to the operator of the vehicle 420. In this fashion, relevancy of the information being presented to the driver is improved.

Similarly, in the case of mobile terminal 430, its planned route 470 may be known by, for example, the use of a navigation or mapping application running on the mobile terminal 430. As such, only condition messages corresponding to traffic lights 440₁ and 440₃ would be presented to the operator of the mobile terminal 430 since those are the only reporting sources that are both within the broadcast area 400, and also along the device's planned route 470.

While the invention has been described in connection with various embodiments, it should be understood that the invention is capable of further modifications. This application is intended to cover any variations, uses or adaptation of the invention following, in general, the principles of the invention, and including such departures from the present disclosure as come within the known and customary practice within the art to which the invention pertains.

1. A method for providing geographically-relevant information to mobile users, the method comprising the acts of:
receiving, by one or more backend servers over a network connection, location-referenced information from an information source, wherein the location-referenced information comprises an indication of a geographic location of the information source;
determining, by the one or more backend servers, a region for which the received location-referenced information is relevant;
determining a size and a shape of the region based on at least one of a type of the location-referenced information, a layout of streets/roads surrounding the information source, and a speed limit surrounding the information source;
identifying, by the one or more backend servers, one or more cellular base stations that provide wireless broadcast service over an actual broadcast region which covers at least a majority of the determined size and shape of the region;
providing, by the one or more backend servers, a condition message to each of the identified cellular base stations, wherein the condition message is based on the location-referenced information; and
instructing, by the one or more backend servers and without carrying out subscriber-specific processing, the identified base stations to wirelessly broadcast the condition message over the actual broadcast region, wherein the condition message is configured to be receivable by cellular-enabled mobile terminals only when located within the actual broadcast region.

2. The method of claim 1, wherein the information source comprises a cellular-capable mobile terminal.

3. The method of claim 1, wherein the location-referenced information comprises information regarding a potentially hazardous traffic condition.

4. The method of claim 1, wherein the location-referenced information comprises at least one of traffic congestion and traffic event information.

5. The method of claim 1, wherein the information source is a traffic light and the location-referenced information comprises signal and phase timing information.

6. (canceled)

7. The method of claim 1, wherein determining the size and the shape of the region comprises determining the size and the shape of the region based, at least in part, on each of the type of the location-referenced information, the layout of streets/roads surrounding the information source, and the speed limit surrounding the information source.

8. The method of claim 1, further comprising instructing, by the one or more backend servers, the identified base stations to repeatedly re-broadcast the condition message over the actual broadcast region for a duration of time.

9. The method of claim 8, wherein the information source is a mobile terminal, and where further the condition message continues to be repeatedly re-broadcast after the information source has left the region.

10. The method of claim 1, further comprises receiving, by the one or more backend servers, additional location-referenced information from a plurality of information sources, and wherein a plurality of condition messages corresponding to the additional location-referenced information that are to be broadcast by the identified cellular base stations in response.

11. The method of claim 10, wherein the plurality of condition messages is filterable by a receiving mobile terminal based on a planned or estimated route of the receiving mobile terminal.

12. A system for providing geographically-relevant information to mobile users, the system comprising:
an information source configured to provide location-referenced information over a network connection, wherein the location-referenced information comprises an indication of a geographic location of the information source; and
a backend server coupled to the network connection and configured to:
receive the location-referenced information,
determine a region for which the received location-referenced information is relevant,
determine a size and a shape of the region based on at least one of a type of the location-referenced information, a layout of streets/roads surrounding the information source, and a speed limit surrounding the information source,
identify one or more cellular base stations that provide wireless broadcast service over an actual broadcast region which covers at least a majority of the determined size and shape of the region,
provide a condition message to each of the identified cellular base stations, wherein the condition message is based on the location-referenced information, and
instruct, without carrying out subscriber-specific processing, the identified base stations to wirelessly broadcast the condition message over the actual broadcast region, wherein the condition message is configured to be receivable by cellular-enabled mobile terminals only when located within the actual broadcast region.

13. The system of claim 12, wherein the information source comprises a cellular-capable mobile terminal.

14. The system of claim 12, wherein the location-referenced information comprises information regarding a potentially hazardous traffic condition.

15. The system of claim 12, wherein the location-referenced information comprises at least one of traffic congestion and traffic event information.

16. The system of claim 12, wherein the information source is a traffic light and the location-referenced information comprises signal and phase timing information.

17. (canceled)

18. The system of claim 17, wherein the backend server is configured to determine the size and the shape of the region based, at least in part, on each of the type of the location-referenced information, the layout of streets/roads surrounding the information source and the speed limit surrounding the information source.

19. The system of claim 12, wherein the backend server is configured to further instruct the identified base stations to repeatedly re-broadcast the condition message over the actual broadcast region for a duration of time.

20. The system of claim 19, wherein the information source is a mobile terminal, and where further the condition message continues to be repeatedly re-broadcast after the information source has left the region.

21. The system of claim 12, further comprising a plurality of information sources which are configured to provide additional location-referenced information, and wherein the backend server is further configured to provide a plurality of condition messages corresponding to the additional location-referenced information that are to be broadcast by the identified cellular base stations.

22. The system of claim 21, wherein the plurality of condition messages is filterable by a receiving mobile terminal based on a planned or estimated route of the receiving mobile terminal.
